(19) United States
(12) Patent Application Publication
(10) Pub. No.: US 2026/0071613 A1
(43) Pub. Date: Mar. 12, 2026

(54) CONTRACTING MEMBER ANCHOR

(71) Applicant: Toyota Motor Engineering & Manufacturing North America, Inc., Plano, TX (US)

(72) Inventors: Erin J. Rutledge, Tipton, MI (US); Michael Paul Rowe, Pinckney, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/324,602

(22) Filed: Sep. 10, 2025

Related U.S. Application Data
(60) Provisional application No. 63/692,818, filed on Sep. 10, 2024.

(51) Int. Cl. F03G 7/06

(52) U.S. Cl. CPC F03G 7/067; F03G 7/06143

(57) ABSTRACT

A system can be used to anchor a contracting member (e.g., a shape memory material member). The system can include a structure including a surface and defining an aperture, a housing, and a contracting member. An end portion of the contracting member can extend through the housing, on the surface of the structure in more than one loop about the aperture, and back through the housing. The housing can be deformed around the contracting member extending through the housing. The system can also include a fastener received in the aperture such that a portion of the contracting member is secured between the surface of the structure and the fastener.

### CROSS-REFERENCE TO RELATED APPLICATIONS

This application claims the benefit of U.S. Provisional Application No. 63/692,818, filed on Sep. 10, 2024, which is incorporated herein by reference in its entirety.

### FIELD

The subject matter described herein relates in general to actuators and, more particularly, to actuators that include contracting members.

### BACKGROUND

Shape memory materials change shape when an activation input is provided to the material. When the activation input is discontinued, the shape memory material returns to its original shape. Shape memory alloys are used in some actuator designs.

### SUMMARY

In one respect, the present disclosure is directed to a system. The system includes a structure that has a surface and that defines an aperture. The system can include a housing. The system can include a contracting member. An end portion of the contracting member can extend through the housing, on the surface of the structure in more than one loop about the aperture, and back through the housing. The housing can be deformed around portions of the contracting member that extending through the housing. The system can include a fastener. The fastener can be received in the aperture such that a portion of the contracting member is secured between the surface of the structure and the fastener.

In another respect, the present disclosure is directed to a system. The system includes a structure that has a surface and that defines an aperture. The system includes a housing. The system includes a wire made of a shape memory material. An end portion of the wire can extend through the housing, on the surface of the structure in at least about one and a half loops about the aperture, and back through the housing. The housing can be deformed around and against portions of the wire that extend through the housing. The system can include a fastener. The fastener can be received in the aperture such that a portion of the wire is secured between the surface and the fastener.

### BRIEF DESCRIPTION OF THE DRAWINGS

FIG. 1 is an example of a system for anchoring a contracting member.

FIG. 2 is a cross-sectional view of the system for anchoring a contracting member of FIG. 1.

FIG. 3 is a view of a portion of the system.

FIG. 4 is another view of the portion of the system.

FIG. 5 is an exploded view of the portion of the system.

FIG. 6 is an example of the system for anchoring a contuator member used in connection with an actuator.

### DETAILED DESCRIPTION

Some actuators use shape memory alloys, such as shape memory alloy wires, for actuation. However, in some cases, the force of the shape memory alloy contraction can be strong enough to separate one or both ends of the shape memory alloy from their respective attachment points. For example, the pulling force of a shape memory alloy wire can be from 150 megapascals (MPa) to about 400 MPa. This pulling force can be greater than the holding force of an attachment mechanism for the ends of the shape memory alloy wire. Consequently, the shape memory alloy wire can become detached from its attachment points. When such detachment occurs, the actuator can no longer provide its intended actuation function and becomes disabled. Accordingly, arrangements described herein are directed to anchoring a shape memory material member or other contracting member to prevent it from becoming detached during actuation.

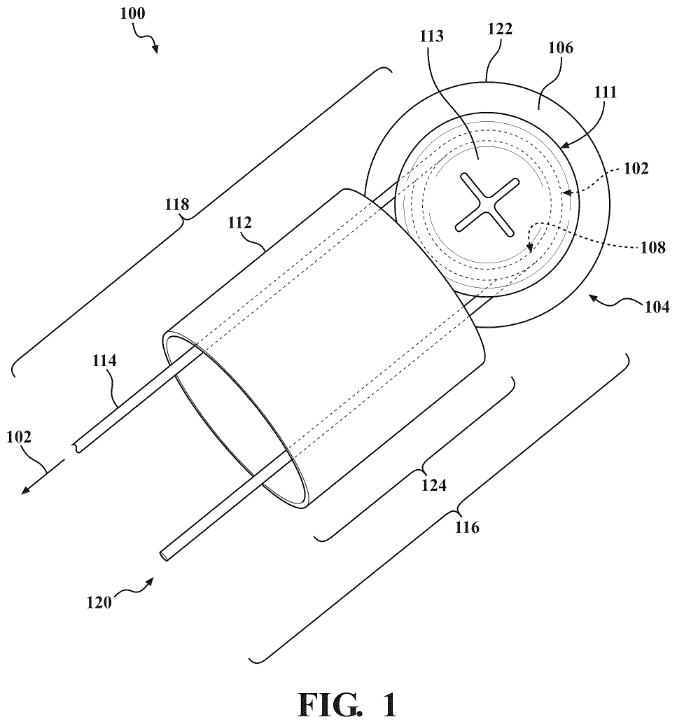

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

FIG. 1 shows an example of a system 100 for anchoring a contracting member of an actuator. When the contracting member is activated, the actuator can be configured to morph into an activated configuration in which a dimension (e.g., a height) of the actuator increases.

There are various suitable actuators that can be used in connection with arrangements described herein. Non-limiting examples of such actuators are described in U.S. Pat. Nos. 10,960,793; 11,370,330; 11,285,844; 11,091,060; 11,603,828; 11,752,901; 11,897,379; 12,152,570; 12,163,507; 12,241,458; 12,270,386; and 12,383,066, which are incorporated herein by reference in their entireties. Additional non-limiting examples of such actuators are described in U.S. Patent Publication Nos. 2023/0191953; 2023/0136197; 2025/0172130; 2025/0058679; 2025/0058688; 2025/0065787; 2025/0065777; 2025/0092862; and 2025/0214265, which are incorporated herein by reference in their entireties. Still further non-limiting examples of such actuators are described in U.S. Patent Application Nos. 63/850,102 and 63/623,930, which are incorporated herein by reference in their entireties. Arrangements described herein can be used in connection with any of the actuators described in the above-noted references.

The actuator can include one or more contracting members. The contracting member(s) can be any structure that, when activated, is configured to shrink in at least one dimension (e.g., length). In one or more arrangements, the contracting member(s) can be one or more shape memory material members 102, one or more active material members, or one or more memory material members. For convenience, the following description will be made in connection with the contracting member being a shape memory material member 102. However, it will be understood that the contracting member is not limited to being a shape memory material member.

When an activation input is provided to the shape memory material member 102, the shape memory material member 102 can contract, thereby causing the actuator to morph into an activated configuration in which a dimension height of the actuator increases. In some arrangements, the contracting member can be a shape memory material member, which can include shape memory alloys and shape memory polymer. As an example, the contracting member can be a shape memory alloy wire.

The phrase “shape memory material” includes materials that changes shape when an activation input is provided to the shape memory material and, when the activation input is discontinued, the material substantially returns to its original shape. Examples of shape memory materials include shape memory alloys (SMA) and shape memory polymers (SMP).

In one or more arrangements, the shape memory material members can be shape memory material wires. As an example, the shape memory material members can be shape memory alloy wires. Thus, when an activation input (e.g., electrical energy, heat, etc.) is provided to the shape memory alloy wire(s), the wire(s) can contract. Shape memory alloy wire(s) can be heated in any suitable manner, now known or later developed. For instance, shape memory alloy wire(s) can be heated by the Joule effect by passing electrical current through the wires. In some instances, arrangements can provide for cooling of the shape memory alloy wire(s), if desired, to facilitate the return of the wire(s) to a non-activated configuration. Of course, it will be appreciated that the activation input can be provided to the shape memory alloy wire(s) in other ways. For example, heated air can be blown on or otherwise directed toward the shape memory alloy wire(s).

The wire(s) can have any suitable characteristics. For instance, the wire(s) can be high temperature wires with austenite finish temperatures from about 80 degrees Celsius to about 110 degrees Celsius. The wire(s) can have any suitable diameter. For instance, the wire(s) can be from about 0.2 millimeters (mm) to about 0.7 mm, from about 0.3 mm to about 0.5 mm, or from about 0.375 millimeters to about 0.5 millimeters in diameter. In some arrangements, the wire(s) can have a stiffness of up to about 70 gigapascals. The pulling force of SMA wire(s) can be from about 150 MPA to about 400 MPa. The wire(s) can be configured to provide an initial moment of from about 300 to about 600 N·mm, or greater than about 500 N·mm, where the unit of newton millimeter (N·mm) is a unit of torque (also called moment) in the SI system. One newton meter is equal to the torque resulting from a force of one newton applied perpendicularly to the end of a moment arm that is one meter long. In various aspects, the wire(s) can be configured to transform in phase, causing the shape memory material members to be moved from non-activated position to an activated position in about 3 seconds or less, about 2 seconds or less, about 1 second or less, or about 0.5 second or less.

The wire(s) can be made of any suitable shape memory material, now known or later developed. Different materials can be used to achieve various balances, characteristics, properties, and/or qualities. As an example, an SMA wire can include nickel-titanium (Ni—Ti, or nitinol). One example of a nickel-titanium shape memory alloy is FLEXINOL, which is available from Dynaolloy, Inc., Irvine, California. As a further example, the SMA wires can be made of Cu—Al—Ni, Fe—Mn—Si, or Cu—Zn—Al.

The SMA wire can be configured to increase or decrease in length upon changing phase, for example, by being heated to a phase transition temperature T_{SMA}. Utilization of the intrinsic property of SMA wires can be accomplished by using heat, for example, via the passing of an electric current through the SMA wire in order provide heat generated by electrical resistance, in order to change a phase or crystal structure transformation (i.e., twinned martensite, detwinned martensite, and austenite) resulting in a lengthening or shortening the SMA wire. In some implementations, during the phase change, the SMA wire can experience a decrease in length of from about 2 to about 8 percent, or from about 3 percent to about 6 percent, and in certain aspects, about 3.5 percent, when heated from a temperature less than the T_{SMA} to a temperature greater than the T_{SMA}.

Other active materials can be used in connection with the arrangements described herein. For example, other shape memory materials can be employed. Shape memory materials, a class of active materials, also sometimes referred to as smart materials, include materials or compositions that have the ability to remember their original shape, which can subsequently be recalled by applying an external stimulus, such as an activation signal.

While the shape memory material members are described, in some implementations, as being wires, it will be understood that the shape memory material members are not limited to being wires. Indeed, it is envisioned that suitable shape memory materials can be employed in a variety of other forms, such as sheets, plates, panels, strips, cables, tubes, or combinations thereof. In some arrangements, the shape memory material members can include an insulating coating or an insulating sleeve over at least a portion of its length.

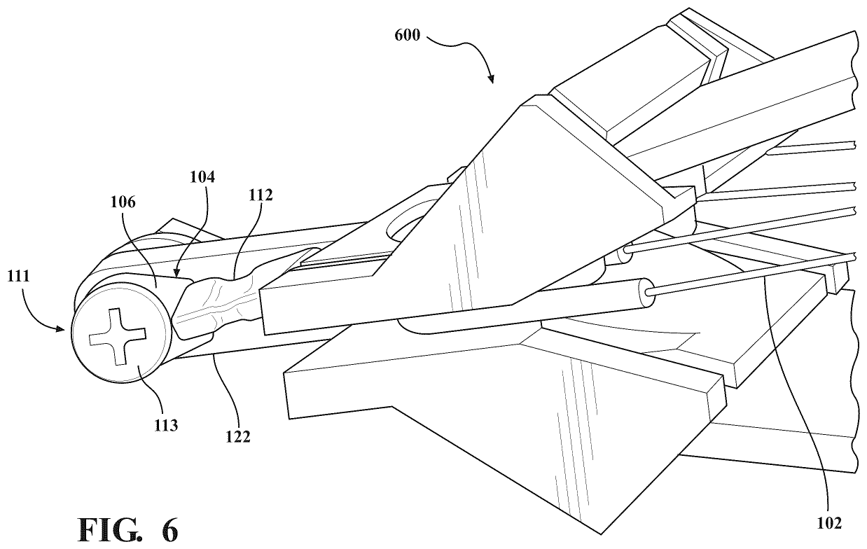

FIG. 1 is an example of a system 100 for anchoring a contracting member, such as a shape memory material member 102 of an actuator. According to arrangements described herein, the shape memory material member 102 can be anchored to prevent separation of the shape memory material member 102 from the actuator body, which separation can defeat the intended purpose of the actuator. It should be noted that FIG. 1 shows the system 100 in a state where a housing 112 is not deformed and therefore does not secure the shape memory material member 102. FIG. 6, by comparison, shows the housing 112 in a deformed condition, which can help to secure the shape memory material member 102.

The system 100 can include a shape memory material member 102. The system 100 can include an a structure with a surface 106 with an aperture 108 defined therein. In one or more arrangements, the structure can be an eyelet 104. However, it will be appreciated that the structure is not limited to being an eyelet.

The aperture 108 can be configured to receive a fastener 111, which can secure the shape memory material member 102. In one or more arrangements, the shape memory material member 102 can extend around the aperture 108 and a shaft 115 (FIG. 5) of the fastener 111. The fastener 111 can be tightened such that the shape memory material member 102 can be sandwiched between the surface 106 of the eyelet 104 and a portion (e.g., a head 113) of the fastener 111. In FIG. 1, the aperture 108 and portions of the shape memory material member 102 and are shown in dashed lines to indicate their position underneath the fastener 111. In some arrangements, the fastener 111 can engage a closure element (e.g., a nut 500 (FIG. 5), a cotter pin, a cap, etc.). In some arrangements, the fastener 111 can threadably engage the aperture 108.

The shape memory material member 102 can pass through the interior of the housing 112, extend in more than one loop about the aperture 108 of the eyelet 104, and pass back through the housing 112. “More than one loop” can include one or more full loops and a portion of another loop. The portion of another loop can be at least about 1% of a loop, at least about 2% of a loop, at least about 3% of a loop, at least about 4% of a loop, at least about 5% of a loop, at least about 10% of a loop, at least about 15% of a loop, at least about 20% of a loop, at least about 25% of a loop, at least about 30% of a loop, at least about 35% of a loop, at least about 40% of a loop, at least about 45% of a loop, at least about 50% of a loop, at least about 55% of a loop, at least about 60% of a loop, at least about 65% of a loop, at least about 70% of a loop, at least about 75% of a loop, at least about 80% of a loop, at least about 85% of a loop, at least about 90% of a loop, at least about 95% of a loop, at least about 96% of a loop, at least about 97% of a loop, at least about 98% of a loop, or at least about 99% of a loop. “More than one loop” can include a plurality of full loops (e.g., two full loops, three full loops, four full loops, etc.) or two or more full loops and a portion of another loop. In some arrangements, “more than one loop”can include at least about one and a half loops.

The more than one loop of the shape memory material member 102 can define an opening 109. The opening 109 can be substantially aligned with the aperture 108 in the eyelet 104. Thus, the fastener 111 can be received with the opening 109 and the aperature 108.

In some arrangements, the surface 106 of the eyelet 104 can be substantially planar. In other examples, the surface 106 can be non-planar. For example, the surface 106 can be substantially curved. While FIG. 1 shows the eyelet 104 being ring-shaped eyelet, it will be appreciated that the eyelet 104 can take a variety of shapes. The eyelet 104 can be substantially flat.

The eyelet 104 can be formed from a variety of materials, including a plastic material, a ceramic material, a composite material, a metallic material, or any other type of material. In some examples, in addition to facilitating the mechanical securement of the shape memory material member 102, the eyelet 104 can also provide an electrical connection between the shape memory material member 102 and an energy source through which the activation input is transmitted to the shape memory material member 102. For example, an electrical contact or trace can be operatively connected to the eyelet 104. The electrical contact/trace can be configured to deliver the activation input to the shape memory material member 102 by way of the physical contact between the eyelet 104 and the shape memory material member 102. In one or more arrangements, the eyelet 104 can be formed of a conductive metallic material to facilitate the transmission of the electrical activation input.

The system 100 can also include the fastener 111. The fastener 111 can help to secure the shape memory material member 102. For instance, the fastener 111 can be received in the aperture 108 such that an end portion 114 of shape memory material member 102 can be positioned between the fastener 111 and the surface 106 of the eyelet 104. The end portion 114 of the shape memory material member 102 can be secured between the fastener 111 and the surface 106 of the eyelet 104.

The fastener 111 can take a variety of forms. In one example, the fastener 111 can be a threaded shaft. The threads of the shaft can be configured to interact with corresponding threads on an inside diameter of the aperture 108, with threads on an actuator body, and/or with a retaining element (e.g., a nut) to secure the shape memory material member 102 to the surface 106 of the eyelet 104. That is, as the threads of the shaft and the corresponding threads in the aperture 108 and/or other engaging structure intermesh and draw the respective bodies towards one another, the shape memory material member 102 can be sandwiched therebetween. A contact force between the surface 106 of the eyelet 104, the shape memory material member 102, and the fastener 111 can retain the shape memory material member 102 in place and prevent slipping of the shape memory material member 102 and/or separation of the shape memory material member 102 from the actuator body to which it is attached. As such, the holding force of the system 100 can be defined, at least in part, by the friction forces between the surface 106 of the eyelet 104, the head of the fastener 111, and the more than one loop of the shape memory material member 102.

While particular reference is made to a particular type of fastener 111, various types of fasteners 111 can be implemented in accordance with the principles described herein, including rivets, bolts, screw, rod, pin, shaft, and the like. As such, the fastener 111 can provide one mechanism to secure the shape memory material member 102 during the operation of an associated actuator.

In an example, the fastener 111 can provide an electrical connection between the shape memory material member 102 and an energy source through which the activation input can be transmitted to the shape memory material member 102. For example, an electrical contact or trace can be operatively connected to the fastener 111. The electrical contact/trace can deliver the activation input to the shape memory material member 102 by way of physical contact between the fastener 111 and the shape memory material member 102. In this example, the fastener 111 can be formed of a conductive metallic material to facilitate the transmission of the electrical activation input.

The system 100 can also include a housing 112 that can be configured to further secure/anchor the shape memory material member 102. An end portion 114 of the shape memory material member 102 can extend through the housing 112, on the surface 106 of the eyelet 104 about the aperture 108, and back through the housing 112 as shown in FIG. 1. As such, the shape memory material member 102 can form a loop, with the segments 116, 118 of the loop passing through the housing 112. As shown in FIG. 1, the end portion 114 of the shape memory material member 102 includes an end 120. In some arrangements, the end 120 can be located outside of the housing 112 while one or more portions 124 of the shape memory material member 102 extends within the housing 112.

The housing 112 can be adjacent to an outside surface 122 of the eyelet 104. For example, the housing 112 can be adjacent and/or tangential to the outside diameter of the eyelet 104. More particularly, the opening of the housing 112 can be adjacent and/or tangential to the outside surface 122 of the eyelet 104. The housing 112 can be adjacent to the eyelet 104 such that at least a portion of the interior surface of the housing 112 is substantially flush with the surface 106 of the eyelet 104. The eyelet 104 can be external to the housing 112.

In some examples, the housing 112 can be operatively connected to the eyelet 104. Any suitable form of operative connection can be used, such as one or more fasteners, one or more welds, one or more brazes, one or more adhesives, one or more forms of mechanical engagement, or any combination thereof. In one or more arrangements, the housing 112 can be affixed to the eyelet 104, with the opening of the housing 112 being adjacent and/or tangential to the outside surface 122 of the eyelet 104. In one or more arrangements, the housing 112 and the eyelet 104 can be integrated with one another. That is, the housing 112 and the eyelet 104 can be a single component or a unitary structure. As an example, the eyelet 104 and the housing 112 can be formed of a single body of material. In one or more arrangements, the eyelet 104 and the housing 112 can be a crimp ring terminal or a ring terminal, just to name a few non-limiting examples.

As described above, FIG. 1 shows the housing 112 in a non-deformed state. The housing 112 can have a substantially enclosed cross-sectional shape and an interior volume.

The housing 112 can be crushed, crimped, or otherwise deformed around the portion(s) 124 of the shape memory material member 102 routed within to help secure the shape memory material member 102 in place. More particularly, the housing 112 can be deformed against both segments 116, 118 of the shape memory material member 102 that pass therethrough. When deformed, the housing 112 can directly contact the shape memory material member 102. In some arrangements, the housing 112 can compress those portions of the shape memory material member 102 that extend through the housing 112. Friction between the deformed housing 112 and the lengths of the shape memory material member 102 disposed therein can prevent sliding or slipping of the shape memory material member 102 responsive to a contraction-inducing activation input. As such, the holding force of the system 100 can be defined, at least in part, by the friction forces between the housing 112 and two segments 116, 118 of the shape memory material member 102.

The housing 112 can be formed of a material that can plastically deform without breaking or cracking. In some examples, the housing 112 can provide an electrical connection between shape memory material member 102 and an energy source through which the activation input is transmitted to the shape memory material member 102. For example, an electrical contact or trace can be operatively connected to the housing 112, which electrical contact/trace is configured to deliver the activation input to the shape memory material member 102 by virtue of physical contact between the housing 112 and the shape memory material member 102. In this example, the housing 112 can be formed of a conductive metallic material to facilitate the transmission of the electrical activation input. In one or more arrangements, the housing 112 can be formed of a metallic material that can be crimped or otherwise compressed around the shape memory material member 102.

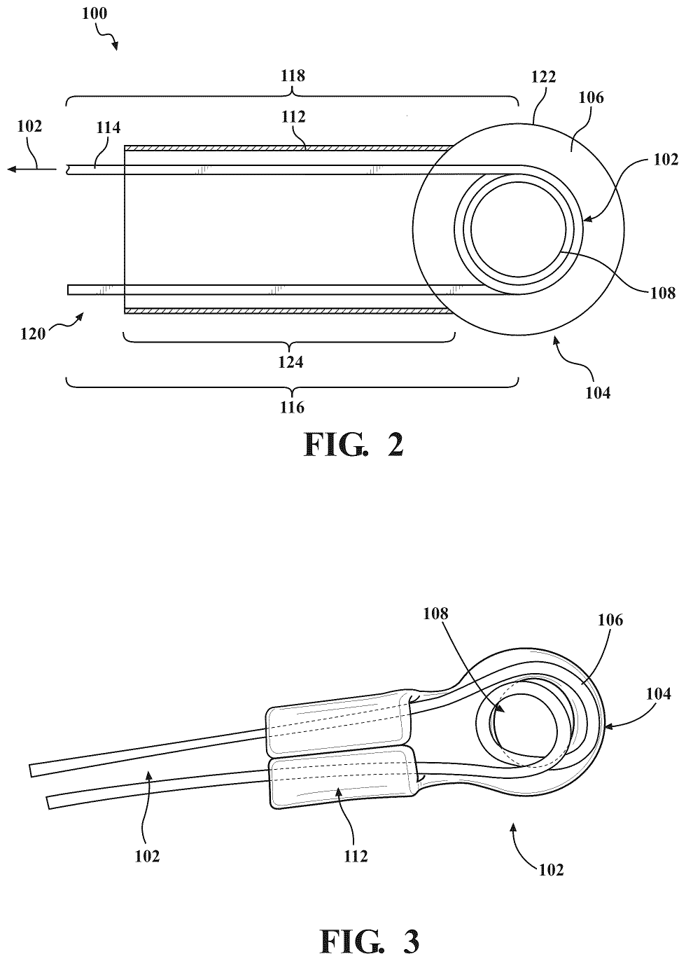

FIG. 2 illustrates a cross-sectional view of the system 100 for anchoring an shape memory material member 102, showing a first arrangement within the housing 112. Specifically, FIG. 2 shows the more than one loop that the shape memory material member 102 can form as it passes around the aperture 108 of the eyelet 104. Here, the shape memory material member 102 can make one full loop and a portion of another loop. The fastener 111 of the system 100 has been omitted from FIG. 2 to facilitate visibility of the aperture 108 and the shape memory material member 102 looped on the surface of the eyelet 104. As depicted in FIG. 2, both segments 116, 118 of the shape memory material member 102 can extend through the housing 112. Doing so can maximize the contact area between the shape memory material member 102 and the housing 112, which, in turn, can maximize the holding force of the housing 112. It should be noted that, in some arrangements, only the shape memory material member 102 is located within the housing 112. Thus, there is no other structure located within the housing 112, and no other structure engages that shape memory material member 102 within the housing.

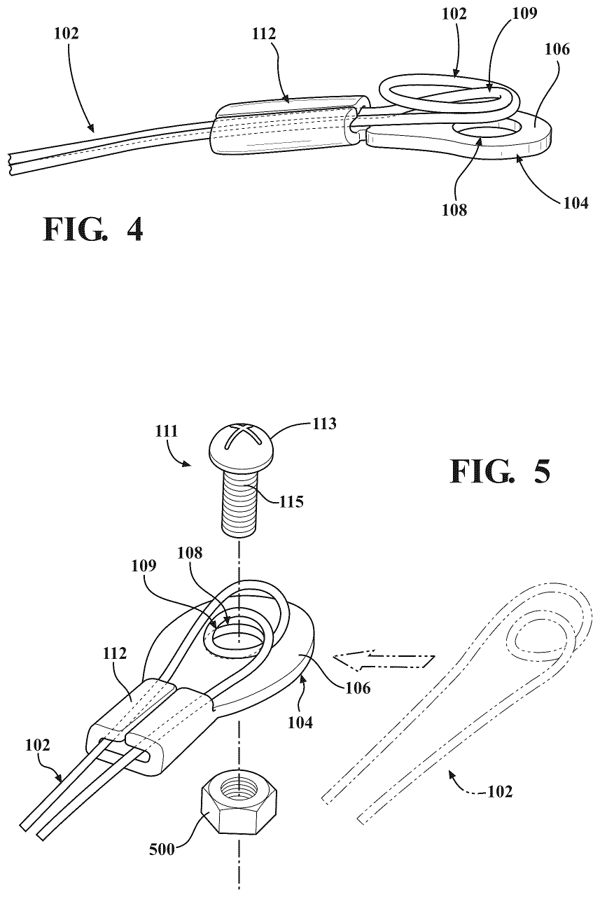

FIGS. 3-5 show different views of portions of the system 100. In FIGS. 3 and 4, only the shape memory material member 102, the housing 112, and the eyelet 104 are shown; the other structures have been omitted for clarity. FIG. 5 is an exploded view of the portion of the system.

The system 100 can be formed in any suitable manner. In some arrangements, the more than one loop of the shape memory material member 102 can be formed prior to the shape memory material member 102 being brought into engagement with the housing 112 and/or the eyelet 104. In other arrangements, the end portion 114 of the shape memory material member 102 can be routed through the housing 112. The more than one loop can be formed in the shape memory material member 102 while the shape memory material member 102 extends along the surface 106 of the eyelet 104. Alternatively, the more than one loop can be formed in the shape memory material member 102 while the shape memory material member 102 is moved away from the surface 106 and then brought back into contact with the surface 106 so that the opening 109 and the aperture 108 are substantially aligned. The shape memory material member 102 can then be routed back through the housing 112. The fastener 111 can be passed through the substantially aligned opening 109 and aperture 108. The fastener 111 can be tightened such that the shape memory material member 102 can be sandwiched between the surface 106 of the eyelet 104 and a portion of the fastener 111. The housing 112 can be crushed, crimped, or otherwise deformed about the portions of the shape memory material member 102 that pass through the housing 112.

FIG. 6 illustrates the system 100 for anchoring the shape memory material member 102. FIG. 6 also depicts a portion of an actuator 600 that can be acted upon by the shape memory material member 102. That is, the system 100 can include the actuator 600. The actuator 600 can include one or more shape memory material members 102. The actuator 600 can have any suitable form. One example of an actuator 600 will be described herein. However, it will be understood that this example is not intended to be limiting. Indeed, there are numerous actuator designs that can include one or more shape memory material members 102.

The actuator 600 can have different portions that are drawn together based on the action of the shape memory material member(s) 102. As an example, the actuator 600 can include a first body member and a second body member, which can be operatively connected to each other by the shape memory material member 102. When an activation input (e.g., electrical energy, heat, etc.) is provided to the shape memory material member 102, the first body member and the second body member can be drawn closer together by the contraction of the shape memory material member 102. When the activation input is removed, the shape memory material member 102 can expand to a non-activated configuration where the first and second body members move away from each other.

The shape memory material member 102 can be operatively connected to the body members of the actuator 600. However, the point of attachment between the shape memory material member 102 and the first and/or second body member can fail when the holding force of the attachment point is less than the pulling force of the shape memory material member 102, causing the shape memory material member 102 to separate from the first and/or second body member. However, arrangements described herein can provide an interface with a holding force that reduces the likelihood of separation of the shape memory material member 102 from the portions of the actuator to which it is anchored. The deformed housing and the fastener can collectively help to anchor the shape memory material member 102 in place during actuation.

FIG. 6 shows an example of the attachment of the shape memory material member 102 to the actuator 600 via the housing 112, eyelet 104, and fastener 111. As described above and as further depicted in FIG. 6, an end portion 114 of the shape memory material member 102 can extend through the housing 112, on the surface 106 of the eyelet 104 about the aperture 108, and back through the housing 112 as depicted in FIG. 1. As such, the shape memory material member 102 can form a loop, with the segments 116, 118 of the loop passing through the housing 112. FIG. 6 also depicts a deformed housing 112 which can compress against the segments 116, 118 of the shape memory material member 102 to prevent sliding or slipping of the shape memory material member 102.

In an example, the fastener 111 and/or the eyelet 104 can be operatively connected to the actuator 600 body member. In the example where the eyelet 104 and the housing 112 form an integrated component, the housing 112 can therefore be operatively connected to the actuator 600 body member. For example, the eyelet 104/housing 112 can be rigidly attached to the actuator 600 body member.

As noted above, arrangements described herein can be used in connection with a variety of actuators that include a contracting member. Further, the more than one loop arrangement of the contracting member, as described herein, can be used in connection with other contracting member anchoring arrangements, including any of those described in U.S. Patent Application Publication No. 2025/0092862, which is incorporated herein by reference in its entirety.

It will be appreciated that arrangements described herein can provide numerous benefits, including one or more of the benefits mentioned herein. For example, arrangements described herein can provide a way of securing a contracting member in an actuator.

Arrangements described herein can withstand more than 200 Newton of actuation force before slippage of the contracting member occurs. Arrangements described herein can do so in a relatively low-cost manner. Arrangements described herein can improve the reliability of contracting-member based actuators. Arrangements described herein can avoid separation of a contracting member, which would render an actuator non-functional.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

As used herein, the term “substantially” or “about” includes exactly the term it modifies and slight variations therefrom. Thus, the term “substantially parallel” means exactly parallel and slight variations therefrom. “Slight variations therefrom” can include within 15 degrees/percent/units or less, within 14 degrees/percent/units or less, within 13 degrees/percent/units or less, within 12 degrees/percent/units or less, within 11 degrees/percent/units or less, within 10 degrees/percent/units or less, within 9 degrees/percent/units or less, within 8 degrees/percent/units or less, within 7 degrees/percent/units or less, within 6 degrees/percent/units or less, within 5 degrees/percent/units or less, within 4 degrees/percent/units or less, within 3 degrees/percent/units or less, within 2 degrees/percent/units or less, or within 1 degree/percent/unit or less. In some instances, “substantially” can include being within normal manufacturing tolerances.

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a structure including a surface and defining an aperture;
a housing;
a contracting member, an end portion of the contracting member extending through the housing, on the surface of the structure in more than one loop about the aperture, and back through the housing, the housing being deformed around portions of the contracting member extending through the housing; and
a fastener received in the aperture such that a portion of the contracting member is secured between the surface of the structure and the fastener.

2. The system of claim 1, wherein the housing is adjacent to an outside surface of the structure.

3. The system of claim 1, wherein the housing is operatively connected to the structure.

4. The system of claim 1, wherein the contracting member is a shape memory material member.

5. The system of claim 4, wherein the shape memory material member is a shape memory alloy.

6. The system of claim 4, wherein the shape memory material member is a wire.

7. The system of claim 1, further comprising an actuator, the contracting member being a portion of the actuator, whereby, when an activation input is provided to the contracting member, the contracting member contracts, thereby causing the actuator to morph into an activated configuration.

8. The system of claim 7, wherein the housing further comprises an electrical contact to transmit the activation input from an energy source to the contracting member.

9. The system of claim 7, wherein the fastener is operatively connected to an actuator body.

10. The system of claim 1, wherein the end portion of the contracting member includes an end, and wherein the end is located outside of the housing.

11. The system of claim 1, wherein the structure is an eyelet.

12. The system of claim 1, wherein more than one loop includes at least about one and a half loops.

13. The system of claim 1, wherein only the portions of the contracting member extending through the housing are located within the housing.

14. The system of claim 1, wherein the housing directly contacts and compresses the contracting member extending through the housing.

15. A system, comprising:
a structure including a surface and defining an aperture;
a housing;
a wire made of a shape memory material, an end portion of the wire extending through the housing, on the surface of the structure in at least about one and a half loops about the aperture, and back through the housing, the housing being deformed around and against portions of the wire extending through the housing; and
a fastener received in the aperture such that a portion of the wire is secured between the surface and the fastener.

16. The system of claim 15, further including an actuator, wherein the wire is a part of the actuator, whereby, when an activation input is provided to the wire, the wire contracts, thereby causing the actuator to morph into an activated configuration.

17. The system of claim 16, wherein the housing further includes an electrical contact to transmit the activation input from an energy source to the wire.

18. The system of claim 16, wherein the fastener is operatively connected to an actuator body.

19. The system of claim 15, wherein the end portion of the wire includes an end, and wherein the end is located outside of the housing.

20. The system of claim 15, wherein only the housing engages the wire within the housing, whereby no other structure engages the wire within the housing.
